(19) United States
(12) Patent Application Publication
(10) Pub. No.: US 2008/0251619 A1
(43) Pub. Date: Oct. 16, 2008

(54) Shredder for Shredding Recyclable Industrial Waste

(76) Inventors: Adolfo Lopez Aguayo, Leon (ES); Avelino Encina Canal, Leon (ES)

Correspondence Address: OSTROLENK FABER GERB & SOFFEN, 1180 AVENUE OF THE AMERICAS, NEW YORK, NY, 100368403, US

(21) Appl. No.: 11/568,431

(22) PCT Filed: Apr. 29, 2004
(86) PCT No.: PCT/ES2004/000186

§ 371 Date: Nov. 1, 2007

(51) Int. Cl. B02C 1/08

(52) U.S. Cl. 241/278.1

(57) ABSTRACT

The invention relates to a shredder comprising a hopper in which industrial waste is deposited. The base of the hopper is equipped with a waste-shredding rotor, while one of the longitudinal edge thereof, which are parallel to the axis of the hopper outlet, is equipped with a longitudinal row of fixed blades which are distributed uniformly along said edge. According to the invention, spaces are provided between the aforementioned blades to enable the passage of moving blades which are mounted to the rotor by means of supports. In addition, half of the fixed blades are disposed at a greater height than the other half, using an alternating arrangement, such that the moving blades act first on one half of the blades and immediately thereafter on the other half, thereby producing a scissors-type effect which facilitates cutting and extends the useful life of such blades.

### OBJECT OF THE INVENTION

This invention concerns a shredder which has been specially designed to carry out the initial treatment of recyclable industrial waste such as tyres, aluminium frames, wood panels, domestic appliances, electronic scrap material, electric conductors etc. specifically at the shredding stage for subsequent separation of their components.

The object of the invention is to obtain a practically universal shredder, that is, one which is able to shred a varied selection of materials, according to their nature and size, with minimum wear of the cutting tools and with easy maintenance, with the addition of excellent performance from a functional or operational perspective.

### BACKGROUND OF THE INVENTION

There are various different types of shredders on the market which are mainly restricted in terms of the fact that each is designed for a specific type of product to be shredded, so that if the specific application is changed for any reason or if there is a need to shred different types of products in the shredder, its performance is reduced, and greater maintenance is required, resulting from breakage or premature wear of the cutting tools, which leads to stoppages in the production process with the associated exploitation costs that this entails.

There are also problems in shredding large scale objects such as agricultural tyres, or those used in civil engineering work

Another frequent problem is the agglomeration of material to be shredded in the shredding chamber due to the effect of the force applied to the cutting tools which then causes the machine to jam.

The maintenance operations for changing the cutting tools tend to be slow and laborious and in addition, wear, mechanical deformation, dirtiness of the shredding zone and fitting parts which need to be changed, considerably hinder replacement operations.

There is a high level of wear in specific components of the machines, particularly in the shredding zone, such as metal plates, rotor, etc.

All this leads to a low shredding capacity in these machines, as in order to avoid mechanical deformation or considerable wear, it is necessary to work at low power and as a result the shredding capacity is similarly diminished.

### DESCRIPTION OF THE INVENTION

The shredder proposed in this invention resolves in a fully satisfactory manner all the various aspects mentioned in the problems expressed above.

Therefore, in a more specific manner and using the basic structure of a conventional shredder, which includes a hopper which holds the recyclable waste, the base of which contains a duly motorised rotor, the characteristics of this shredder are based fundamentally on the aforementioned rotor, and more specifically on the cutting elements which are included and which collaborate with it, constituting the actual shredding elements which act with a “scissors” effect, maximising the effectiveness of the shredder.

Specifically, on one of the sides of the lower opening of the hopper, the one on which rotor blades act at the outlet of the hopper, there are a number of fixed blades, distributed with a convenient distance between each other in order to permit the moving blades associated with the rotor to pass between them, and which have two significant characteristics, on one hand, their upper or operating edges are set at different heights so that by means of an alternating arrangement in respect to higher or lower blades, optimum distribution of effort is achieved, the cutting effect does not occur simultaneously on all of them but first on one half and then the other, which for the same applied power results in a greater effectiveness and capacity of shredding, while at the same time, and complementary to this effect, these fixed blades are attached by means of screws, the heads of which are embedded in the blades themselves, and therefore those heads are not subject to any wear or mechanical deformation and thus in turn this considerably facilitates their dismantling during maintenance tasks.

These blades also have various useful surfaces, so that by simply changing their position, their useful life may be extended with the consequent reduction in maintenance costs.

In accordance with another of the characteristics of the invention, the power is applied to the rotor by two identical motors which, by means of reducing gears which are also identical, transmit movement to the drive axle on both ends in a completely homogeneous manner, thus avoiding asymmetric wear of the gears.

Each motor is coupled to the corresponding gear by means of an elastic coupling which avoids any problems due to “knocking” between the rotor and the shredder stator which may occur during shredding.

### DESCRIPTION OF THE DRAWINGS

In order to complete the present description and to help provide a better understanding of the characteristics of the invention, in accordance with a preferential example of the practical embodiment of the same, a set of drawings is attached hereto by way of illustration as an integral part of this description and in no way restrictively, representing the following:

FIG. 1—Shows a diagram with an elevational view of a shredder for shredding industrial recyclable waste manufactured in accordance with the object of the present invention.

FIG. 2—Shows a profile of the same shredder

FIG. 3—Indicates a plan view of the shredder shown in the previous figures

FIG. 4—Shows an enlarged detail, also in plan view, of the power transmission system to the rotor of the shredder.

FIG. 5—Shows a detail in cross section: at the lower level of the hopper, specifically at the rotor location.

FIG. 6—Shows a diagram of the detailed area of the previous figure corresponding to the location of the fixed blades where their different height levels can be observed.

FIG. 7—Shows a plan view and a section of a fixed blade.

FIG. 8—Shows a similar representation to FIG. 7 but that corresponding to a moving blade.

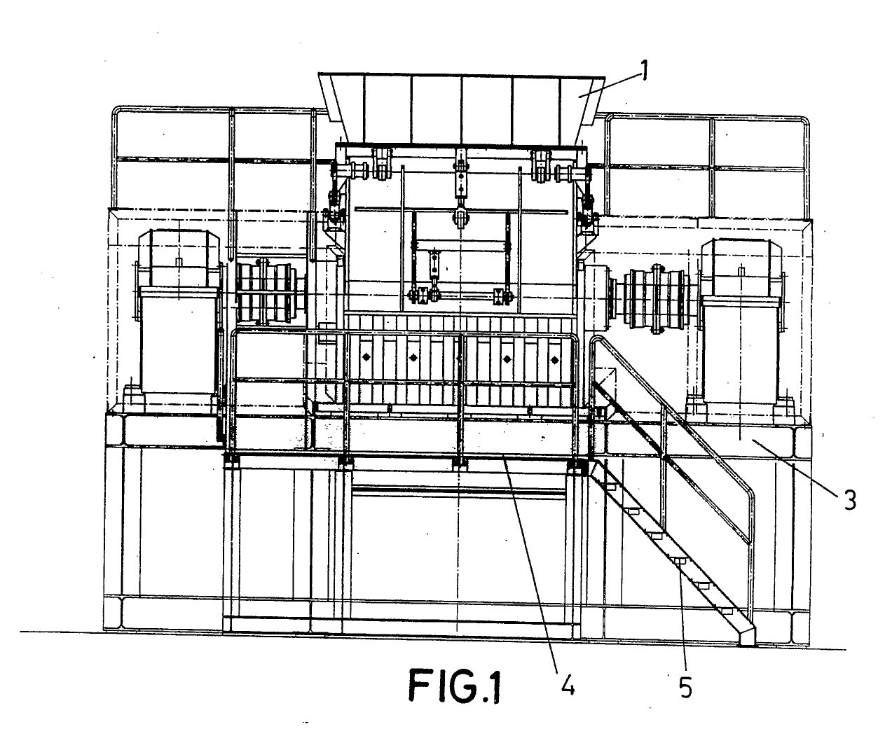

### PREFERRED EMBODIMENT OF THE INVENTION

In the light of the figures indicated it may be seen how the shredder proposed in this invention incorporates the essential hopper (1) for depositing the industrial waste to be shredded, with a lateral groove (2) at its opening which facilitates the deposit of the waste inside the hopper (1) which, together with its accompanying mechanisms, rests on a bedplate (3) which appropriately elevates it above ground, a maintenance platform (4) being located next to it which is accessed with a step ladder (5).

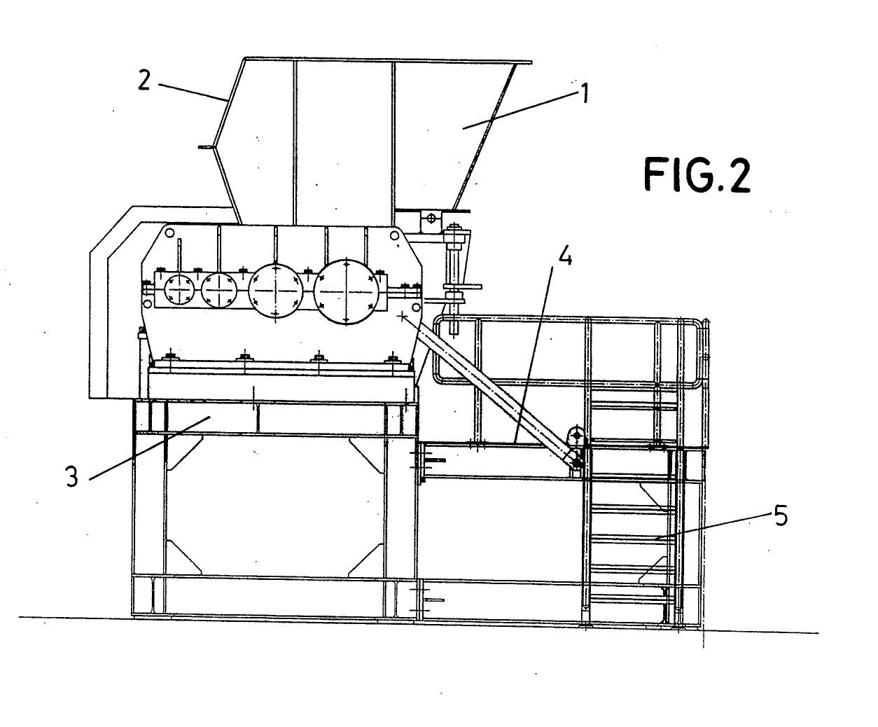

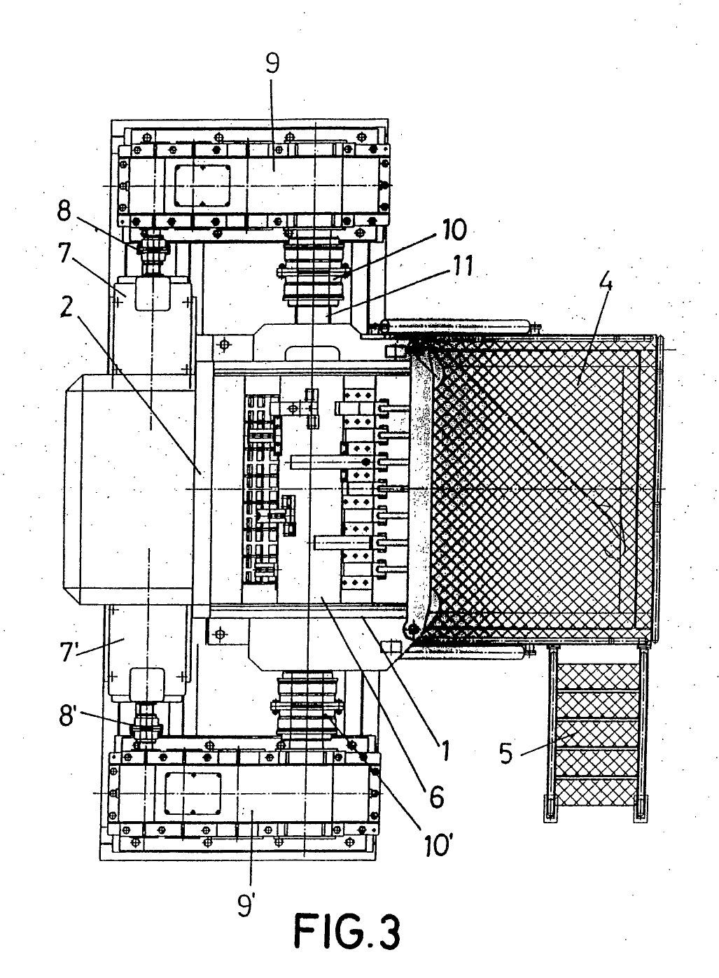

In the lower opening of the hopper (1) the rotor (6) is located, which receives movement from both ends, supplied by the respective electric motors (7-7′) which, by means of elastic couplings (8-8′) supply movement to the mechanical and symmetrical reducing gears (9-9′), the axle arrangement of which is schematically represented in FIG. 2, reducing gears (9-9′) which are finally and by means of mechanical rigid couplings (10-10′), fixed to the respective ends of the axle (11) of the rotor (6).

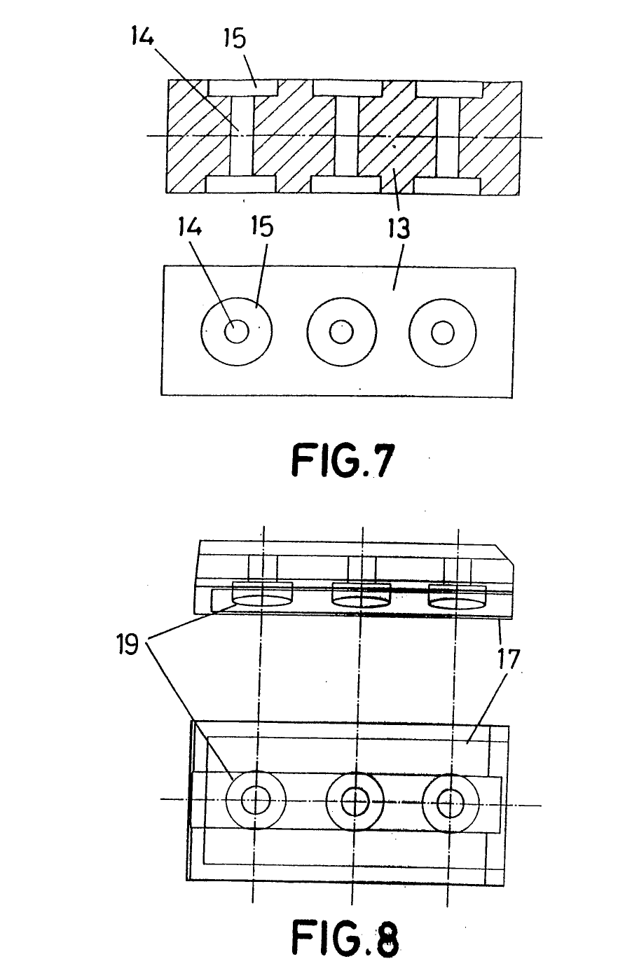

In the lower opening (12) of the hopper (1), where the rotor (6) operates and specifically in one of the edges parallel to this, there are a number of fixed blades (13) such as the blade represented in detail in FIG. 7, which are attached by means of screws which pass though holes (14) and whose heads are embedded in the blades themselves (13) specifically in widenings (15) of those holes (14) so that the heads will remain clear of the working area of the shredder, and perfectly protected in the groove (15).

These fixed blades (13) are uniformly distributed along the edge of the entrance (12) to the hopper (1), leaving empty spaces between each other (16) for the passage of the moving blades (17), which shall be described below.

In addition, and as may be seen in FIG. 6, the fixed blades (13) are set at different heights, so that the moving blades (17) firstly attack one half of the fixed blades (13) and immediately after attack the other half, so that as the blades (13) of one and the other height are alternately arranged as may be seen in FIG. 6, an improvement the cutting effect is achieved, specifically the aforementioned “scissors” effect, as at all times a moving blade (17) acts on a fixed blade (13) and subsequently on the other.

Returning once more to the moving blades (17), these are mounted on the front of the respective supports (18) in the form of a half moon, duly attached to the rotor (6) so that the moving blades (17) are noticeably parallel to the fixed blades (13) at the moment of cutting, with the aforementioned moving blades (17) attached to their supports (18) by means of screws (19) the heads of which are equally embedded and protected inside the blades, thus not being subject to any wear or mechanical deformation.

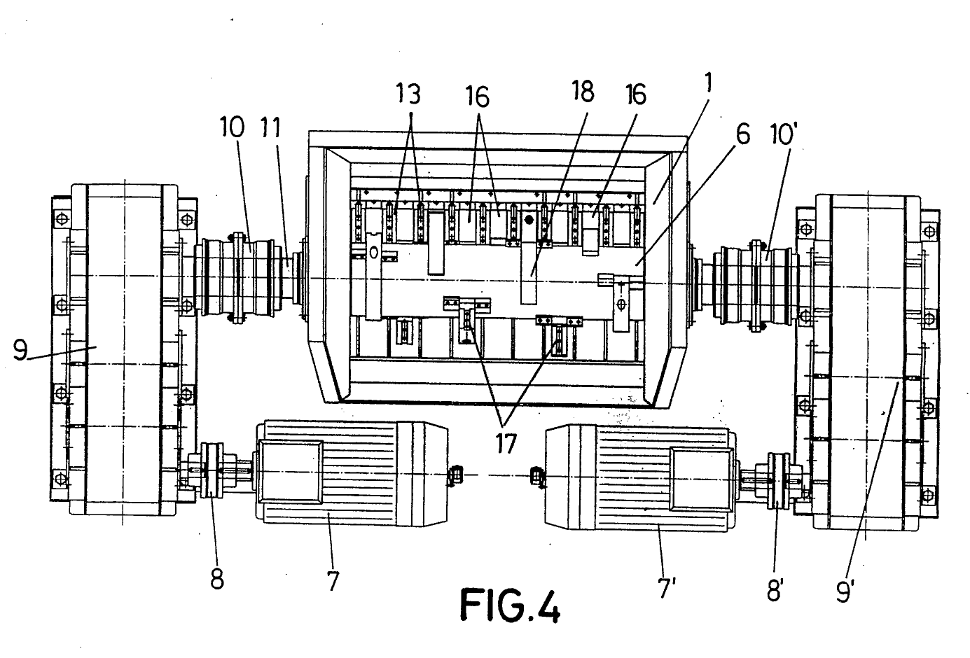

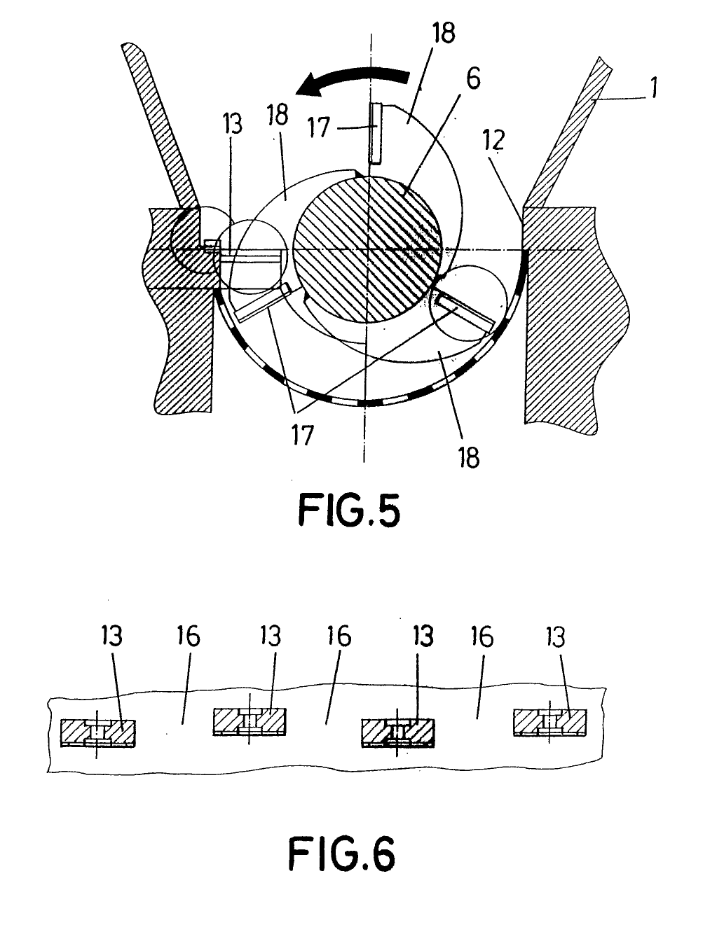

The moving blades (17) are also mounted slightly out of phase as may be seen specifically in FIG. 4 in order to participate in the aforementioned “scissors” effect.

1. A shredder for shredding industrial recyclable waste of the type which incorporates a hopper to receive said waste, in the bottom or outlet of which there is a rotor, which is appropriately motorised and which has moving blades which collaborate with fixed blades arranged on one of the edges of the aforementioned outlet opening parallel to the rotor axle, wherein the aforementioned fixed blades are uniformly distributed along the edge, defining spaces between each other for the passage of the moving blades, which the special particularity that the fixed blades are set, with the special particularity that the fixed blades are set differently in terms of height, specifically half of them being disposed in an alternate arrangement with half the blades at a position noticeably higher than the outer half in order to ensure that the moving blades act firstly on half of the fixed blades and immediately after on the other half, thus obtaining a “scissors” effect when cutting the waste.

2. Shredder for shredding recyclable industrial waste according to claim 1, wherein both the fixed blades and the moving blades are attached using screws whose heads are embedded in the blades themselves, in areas of the blades which are subject to wear or mechanical deformation during normal operation of the shredder.

3. Shredder for shredding recyclable industrial waste according to claim 1, wherein the distance between the fixed blades is slightly superior to the width of the moving blades in order to diminish the wear on these, to facilitate cutting and to avoid build-up of the product.

4. Shredder for shredding recyclable industrial waste according to claim 1, wherein the blades have various useful surfaces which, by changing their positions, an extension of their useful life is obtained.

5. Shredder for shredding recyclable industrial waste according to claim 1, wherein the rotor receives movement at both ends from two motors, preferentially electric, through respective reducing gears, also identical, in such a way that the mechanical force applied to the rotor is identical at both ends, avoiding asymmetric wear of the reducing gears.

6. Shredder for shredding recyclable industrial waste according claim 5 wherein each motor is coupled to the corresponding reducing gear by means of an elastic coupling, while each reducing gear is attached to the corresponding end of the axle of the rotor by means of a rigid mechanical coupling.
